(19) United States
(12) Patent Application Publication
(10) Pub. No.: US 2014/0149701 A1
(43) Pub. Date: May 29, 2014

(54) BACKUP METHOD AND COMPUTER PRODUCT

(71) Applicant: FUJITSU LIMITED, Kawasaki-shi (JP)

(72) Inventors: Yukio Osada, Setagaya (JP); Satoru Sankoda, Kawasaki (JP); Yunosuke Ishinabe, Yokohama (JP); Masashi Kamijyo, Naka (JP)

(73) Assignee: FUJITSU LIMITED, Kawasaki-shi (JP)

(21) Appl. No.: 14/170,109

(22) Filed: Jan. 31, 2014

Related U.S. Application Data
(63) Continuation of application No. PCT/JP2011/069674, filed on Aug. 30, 2011.

(51) Int. Cl. G06F 3/06

(52) U.S. Cl. CPC G06F 3/065; G06F 3/0619; G06F 3/0677
USPC 711/162

(57) ABSTRACT

A backup method includes detecting a first OS that is to be backed up, among plural OSs running on a computer and exclusive of a second OS; extracting information concerning resources used by the first OS among resources of the computer, the information being extracted upon detecting the first OS and from a first memory area that the second OS is authorized to access and that the first OS is not authorized to access; copying the information from the first memory area to a second memory area that the second OS and the first OS are authorized to access; and backing up the information of resources after copying the information to the second memory area. The backup method is executed by the computer.

### CROSS REFERENCE TO RELATED APPLICATIONS

This application is a continuation application of International Application PCT/JP2011/069674, filed on Aug. 30, 2011 and designating the U.S., the entire contents of which are incorporated herein by reference.

### FIELD

The embodiment discussed herein is related to a backup method and a computer product.

### BACKGROUND

A disk image of a PC is usually backed up as a precautionary measure in the event of physical damage to the computer or changes in the environment of the computer. The disk image of the computer includes program code and data of the operating system (OS). The disk image of the computer may also include the program code and data of application software (hereinafter, “app”) that is executed using a library of the OS.

As a related technique, for example, an OS deploying method is known, according to which a disk image and information concerning resources, such as hardware, of an OS-acquiring computer are stored in memory and information concerning resources of an OS-deployed computer and of the OS-acquiring computer are compared to determine whether or not to deploy an OS. According to another known technique, an image of a virtual machine (virtual computer) executed by a virtual machine monitor (VMM) is backed up. When backup for the virtual machine is performed, information related to resources of the virtual machine is backed up similarly to a physical environment for the virtual machine. As a prior technique related to virtual machines, for example, a technique is disclosed, according which image files of a guest OS and an app that run on a virtual machine are encrypted or provided with digest values added to the image files, and are distributed. For examples of such techniques, refer to Japanese Laid-Open Patent Publication Nos. 2009-122963 and 2009-187247.

Nonetheless, according to the above conventional techniques, information concerning resources of the virtual machine, such as hardware, is possessed by a host OS that supervises the virtual machine, making it difficult for a guest OS to perform backup because the guest OS is not authorized to access the information concerning resources.

### SUMMARY

According to an aspect of an embodiment, a backup method includes detecting a first OS that is to be backed up, among plural OSs running on a computer and exclusive of a second OS; extracting information concerning resources used by the first OS among resources of the computer, the information being extracted upon detecting the first OS and from a first memory area that the second OS is authorized to access and that the first OS is not authorized to access; copying the information from the first memory area to a second memory area that the second OS and the first OS are authorized to access; and backing up the information of resources after copying the information to the second memory area. The backup method is executed by the computer.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an operation example according to a backup method of an embodiment;

FIG. 2 is a block diagram of a hardware configuration of a data processing apparatus according to the embodiment;

FIGS. 3A and 3B are block diagrams of examples of software of the information processing apparatus;

FIG. 4 is a block diagram of an example of functions of the information processing apparatus;

FIG. 5 is an explanatory diagram of an example of the contents of a backup image file;

FIG. 6 is an explanatory diagram of an example of the contents of a guest machine management table;

FIG. 7 is an explanatory diagram (1) of an example of operation during a backup process;

FIG. 8 is an explanatory diagram (2) of an example of operation during the backup process;

FIG. 9 is an explanatory diagram (3) of an example of operation during the backup process;

FIG. 10 is a flowchart (1) of an example of the backup process;

FIG. 11 is a flowchart (2) of an example of the backup process;

FIG. 12 is a flowchart of an example of a configuration file backup process by an agent; and

FIG. 13 is a flowchart of an example of an image backup process by a backup tool.

### DESCRIPTION OF EMBODIMENTS

Embodiments of a backup method and a computer product will be described in detail with reference to the accompanying drawings.

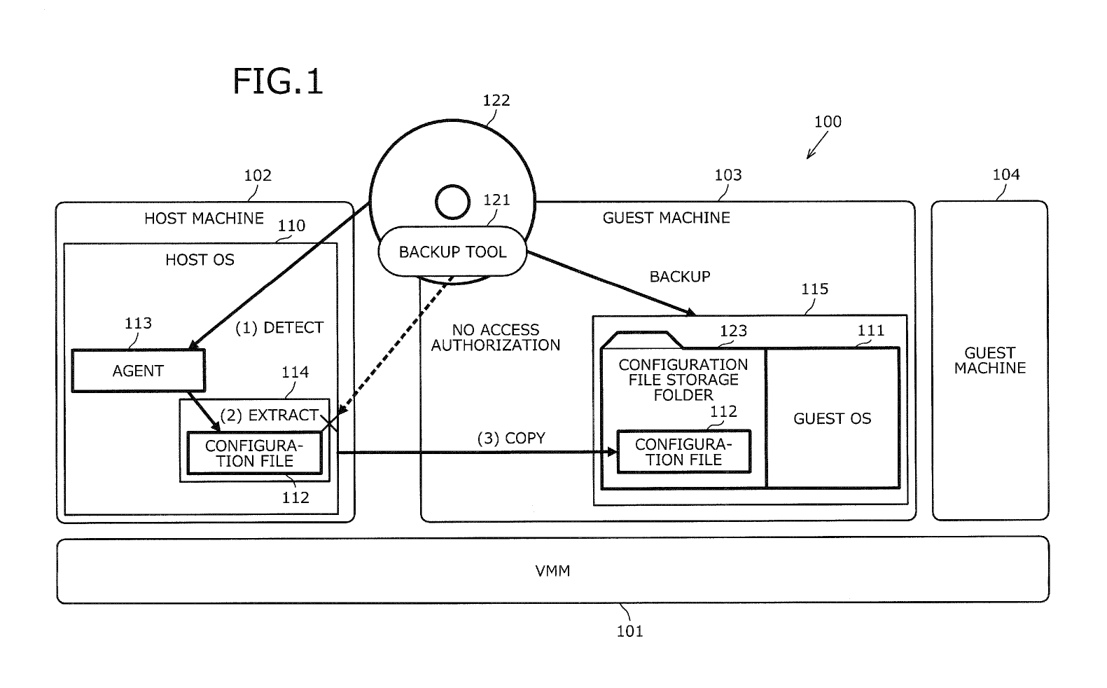

FIG. 1 is an explanatory diagram of an operation example according to a backup method of an embodiment. An example of operation of an information processing apparatus 100 that executes the backup method of the embodiment will be described, with reference to FIG. 1. The information processing apparatus 100 includes a host machine 102 that supervises guest machines of the information processing apparatus 100, including a guest machine 103 and a guest machine 104, and executes the guest machines 103 and 104 on a VMM 101.

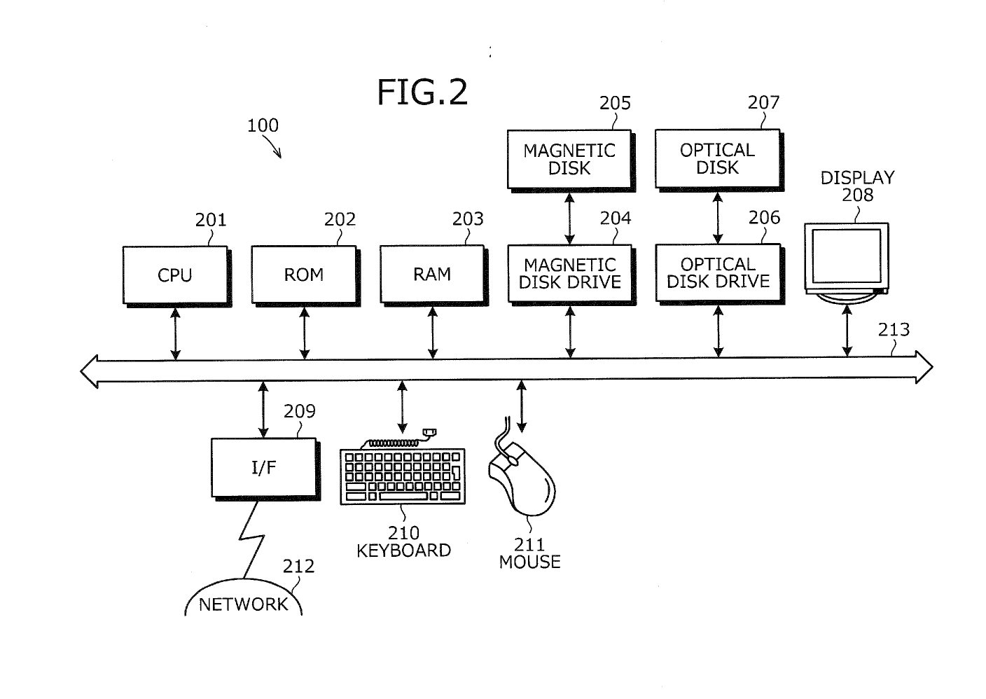

The VMM 101 is software that virtualizes computers to perform control for executing multiple OSs. The host machines 102 to 104 are virtual machines, which are virtual computers that run on the information processing apparatus 100. For example, the host machines 102 to 104 are software that virtualizes a CPU, memory, etc., making up hardware resources of the information processing apparatus 100 and that provides software running on a virtual machine with a virtualized execution environment. For example, the host machine 102 executes a host OS 110 and the guest machine 103 executes a guest OS 111. The hardware of the information processing apparatus 100 will be described later with reference to FIG. 2.

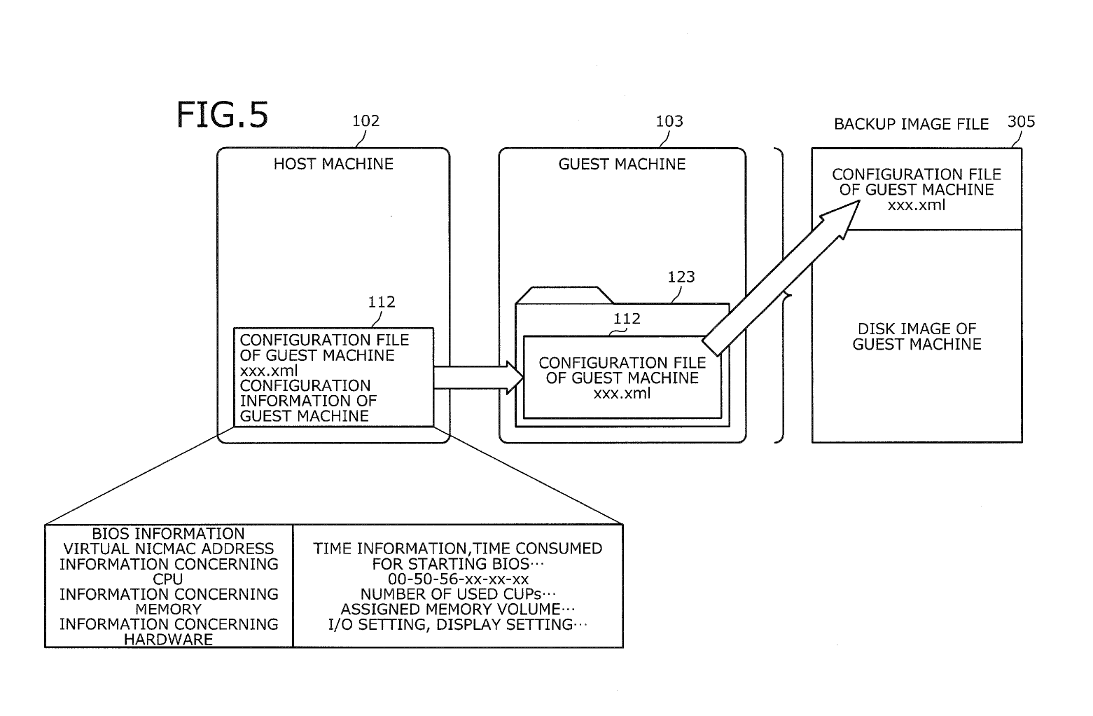

The host machine 102 supervises the guest machines 103 and 104. For example, the host machine 102 assigns hardware resources of the information processing apparatus 100 to the guest machines 103 and 104. For example, information concerning resources used by a virtual machine (hereinafter “configuration information”) is described in a configuration file 112. A specific example of the configuration file 112 is depicted in FIG. 5 later. The configuration file 112 is stored in a host OS managed area 114, which is a first memory area to which the host OS 110 is authorized to access and the guest OS 111 is not authorized to access.

The host OS 110 executes an agent component (hereinafter “agent”) 113. The agent 113 monitors the start of a backup process at any one among the guest machine 103 and the guest machine 104.

The backup process is executed as the process of backing up the guest OS 111 when an OS that is to be backed up is the guest OS 111. When configuration information is stored to a virtual hard disk (VHD) file 115 that is a second memory area that the guest OS 111 is authorized to access, the backup process includes backing up the configuration information. When an app that is executed by using a library for the OS is stored in the second memory area, the backup process may include backing up the program code and data of the app. The VHD file 115 is a file formatted in a file structure similar to a hard disk structure.

Under the above conditions, a case is assumed where a recording medium 122 that stores a backup tool 121 that executes the backup process is installed in the information process apparatus 100 by an administrator, etc., of the virtual machine. The recording medium 122 is, for example, an optical disk, such as compact disk (CD), or a portable flash read-only memory (ROM).

The agent 113 executes a first process in which the agent 113 detects the guest OS 111 as an OS that is to be backed up. For example, when the recording medium 122 is installed, the agent 113 may detect an OS that is to be run as the OS that is to be backed up. When the host OS 110 can detect the restart of the guest OS 111, the agent 113 may detect the restarted guest OS as the OS that is to be backed up.

When an OS that is to be backed up is detected, the agent 113 executes a second process in which the agent 113 extracts the configuration file 112 corresponding to the guest OS 111, and from the host OS managed area 114, which is the first memory area. The agent 113 then executes a third process in which the agent 113 copies the configuration file 112 to the VHD file 115, which is the second memory area, before the VHD file 115 is mounted by the guest OS 111 or the backup tool 121. If a configuration file storage folder 123 is present in the VHD file 115, the agent 113 may copy the configuration file 112 to the configuration file storage folder 123. After the copying, the backup tool 121 mounts and reads the VHD file 115, thus backing up the configuration file 112 that includes the guest OS 111.

In this manner, by copying the configuration file 112 to the area that the guest OS 111 is authorized to access, the agent 113 can back up the configuration file 112 without giving the authority of the host OS 110 to the guest OS 111. The information processing apparatus 100 that executes the operation of FIG. 1 will be described, with reference to FIGS. 2 to 13.

FIG. 2 is a block diagram of a hardware configuration of the data processing apparatus according to the embodiment. As depicted in FIG. 2, the data processing apparatus 100 includes a central processing unit (CPU) 201, read-only memory (ROM) 202, random access memory (RAM) 203, a magnetic disk drive 204, a magnetic disk 205, an optical disk drive 206, an optical disk 207, a display 208, an interface (I/F) 209, a keyboard 210, and a mouse 211, respectively connected by a bus 200.

The CPU 201 governs overall control of the data processing apparatus 100. The ROM 202 stores therein programs such as a boot program. The RAM 203 is used as a work area of the CPU 201. The magnetic disk drive 204, under the control of the CPU 201, controls the reading and writing of data with respect to the magnetic disk 205. The magnetic disk 205 stores therein data written under control of the magnetic disk drive 204.

The optical disk drive 206, under the control of the CPU 201, controls the reading and writing of data with respect to the optical disk 207. The optical disk 207 stores therein data written under control of the optical disk drive 206, the data being read by a computer.

The display 208 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 208.

The I/F 209 is connected to a network 212 such as a local area network (LAN), a wide area network (WAN), and the Internet through a communication line and is connected to other apparatuses through a network 212. The I/F 209 administers an internal interface with the network 212 and controls the input and output of data with respect to external apparatuses. For example, a modem or a LAN adaptor may be employed as the I/F 209.

The keyboard 210 includes, for example, keys for inputting letters, numerals, and various instructions and performs the input of data. Alternatively, a touch-panel-type input pad or numeric keypad, etc. may be adopted. The mouse 211 is used to move the cursor, select a region, or move and change the size of windows. A track ball or a joy stick may be adopted provided each respectively has a function similar to a pointing device.

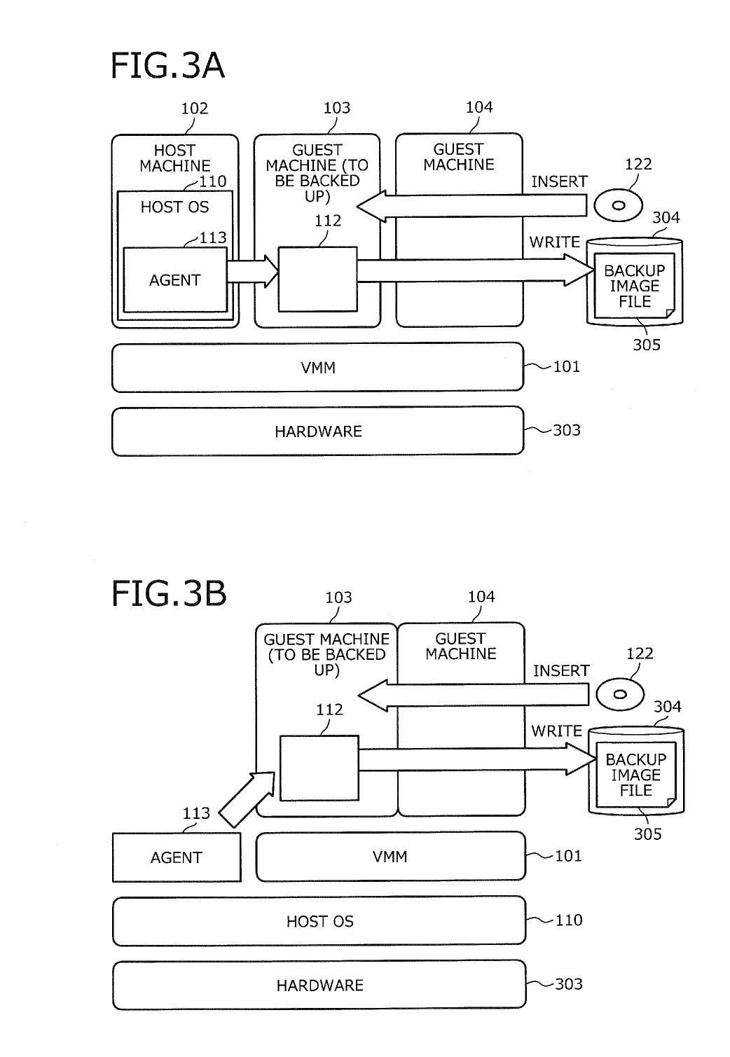

FIGS. 3A and 3B are block diagrams of examples of software of the information processing apparatus. FIG. 3A depicts an example of software in a case where the information processing apparatus 100 builds a hypervisor type virtualization environment. FIG. 3B depicts an example of software in a case where the information processing apparatus 100 builds a host OS type virtualization environment.

In FIG. 3A, the hypervisor type VMM 101 directly controls hardware 303 and executes the host machine 102 and the guest machines 103 and 104. The agent 113 executed by the host OS 110 of the host machine 102 detects installation of the recording medium 122 and copies the configuration file 112. The backup tool 121 stored in the recording medium 122 writes the guest OS 111 and the copied configuration file 112 to a backup image file 305 in a disk 304. In this manner, the information processing apparatus 100 of this embodiment builds the hypervisor type virtualization environment. However, the information processing apparatus 100 may build the host OS type virtualization environment.

In FIG. 3B, the information processing apparatus 100 executes the host OS 110 that controls the information processing apparatus 100. The host OS 110 executes the agent 113 and the VMM 101, treating each of them as one of apps of the host OS 110. The agent 113 detects installation of the recording medium 122 and copies the configuration file 112. The backup tool 121 stored in the recording medium 122 writes the guest OS 111 and the copied configuration file 112 to the backup image file 305 in the disk 304.

The disk 304 is provided as the magnetic disk 205, optical disk 207, etc., of FIG. 2. The backup image file 305 is copied information created by backing up software as an image file. The functions of the agent 113 and the backup tool 121 will then be described.

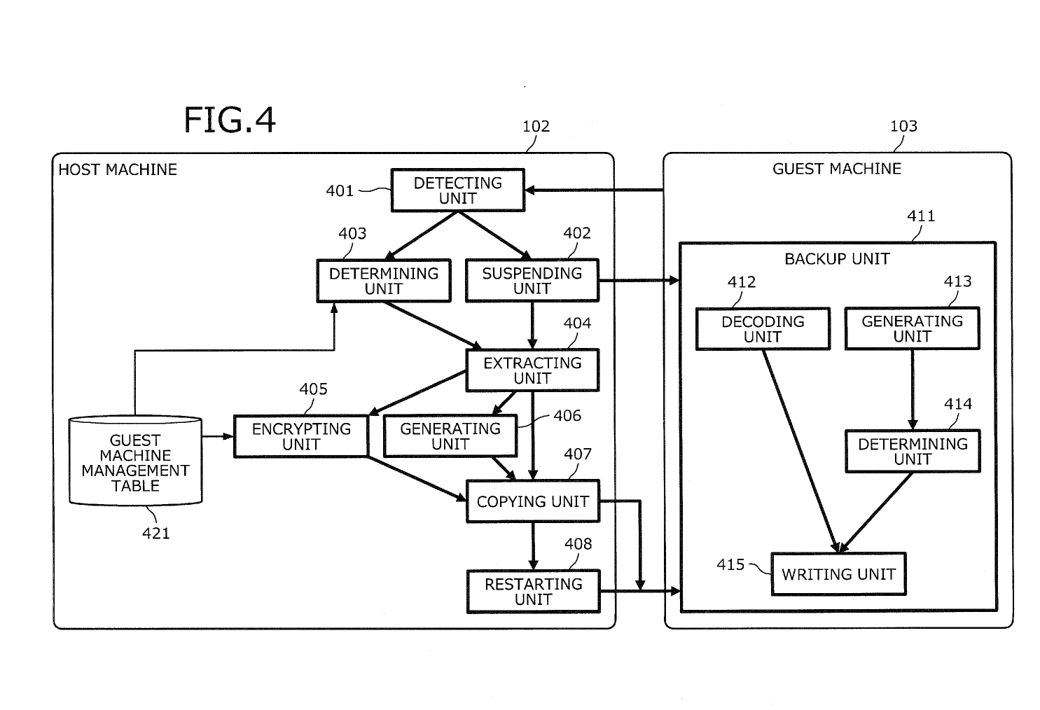

The functions of the information processing apparatus 100 will be described. FIG. 4 is a block diagram of an example of the functions of the information processing apparatus. The information processing apparatus 100 includes a detecting unit 401, a suspending unit 402, a determining unit 403, an extracting unit 404, an encrypting unit 405, a generating unit 406, a copying unit 407, and a restarting unit 408. The information processing apparatus 100 further includes a backup unit 411, a decoding unit 412, a generating unit 413, a determining unit 414, and a writing unit 415.

These functional units (detecting unit 401 to writing unit 415) serving as a control unit are implemented when the CPU 201 executes a program stored in a memory device. The memory device is, for example, the ROM 202, RAM 203, magnetic disk 205, optical disk 207, etc. of FIG. 2. The functional units may be implemented by a program that is executed by another CPU though the I/F 209.

The detecting unit 401 to the restarting unit 408 represent functions of the agent 113 executed by the host machine 102. The backup unit 411 to the writing unit 415 represent functions of the backup tool 121 executed by the guest machine 103. Although the backup unit 411 to the writing unit 415 are defined as functions of the backup tool 121 executed by the guest machine 103 booted up by an OS in the recording medium 122, the backup unit 411 to the writing unit 415 may be functions of the backup tool 121 executed by the host OS 110.

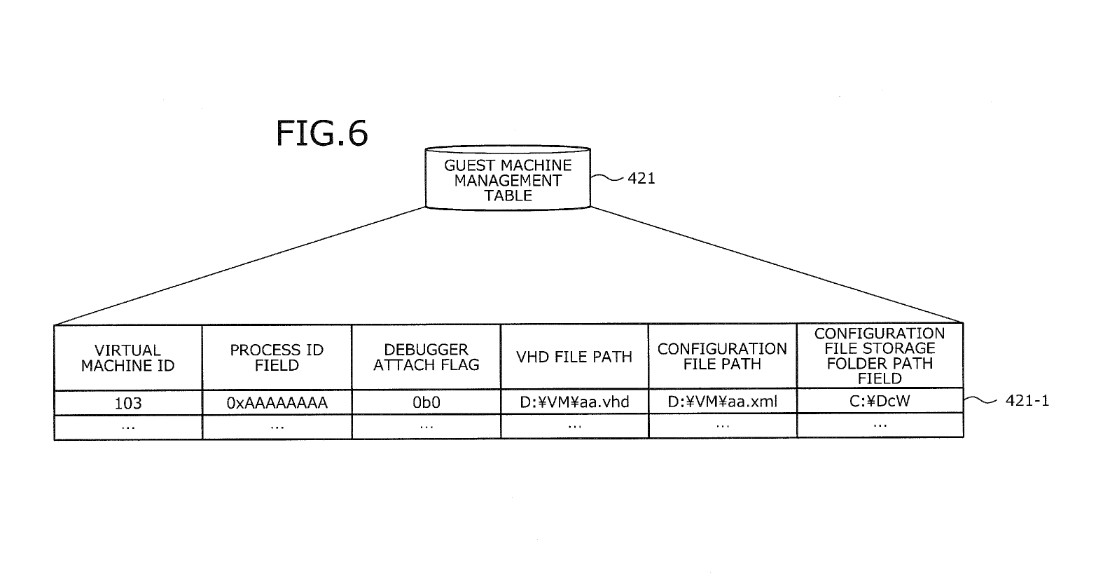

The information processing apparatus 100 can access a guest machine management table 421 storing therein supervising information of the guest machines. The details of the guest machine management table 421 will be described later with reference to FIG. 6.

The detecting unit 401 has a function of detecting an OS that is to be backed up and is not a particular OS among multiple OSs running on a computer. For example, the detecting unit 401 detects the guest OS 111, which is not the host OS 110 that is designated as the particular OS, as an OS that is to be backed up among the host OS 110 and the guest OS 111 running on the information processing apparatus 100. When the detecting unit 401 can detect the restart of a guest machine, the detecting unit 401 may detect a restarted OS as an OS that is to be backed up. The detecting unit 401 may be executed by the host OS serving as the particular OS or by another OS different that is not the host OS or the OS that is to be backed up. OSs running on the information processing apparatus 100 include one host OS 110 and one or more guest OSs.

The detecting unit 401 may detect the recording medium 122 in a computer-readable state, and when detecting the recording medium 122 in such a state, may detect an OS that is to be run among multiple OSs, as an OS that is to be backed up. The OS that is to be run is an OS that receives user input from the keyboard 210, mouse 211, etc.

If the recording medium 122 is the optical disk 207, a case where the recording medium 122 is in a computer-readable state refers to a case where the optical disk 207 is installed in the information processing apparatus 100 to put the optical disk 207 in a readable state. If the recording medium 122 is a portable flash ROM, a case where the recording medium 122 is in a readable state is equivalent to a case where the flash ROM is connected to the information processing apparatus 100 to put the flash ROM in a readable state.

If the recording medium 122 is the magnetic disk 205 or an international organization for standardization (ISO) image file stored on a server, etc. connected to the information processing apparatus 100 through the network 212, a case where the recording medium 122 is in a readable state is equivalent to a case where the ISO image file is mounted. Identification information of the detected OS that is to be backed up is stored to the memory area of the ROM 203, magnetic disk 205, optical disk 207, etc.

The suspending unit 402 has a function of suspending a process of backing up an OS that is to be backed up before the second memory area is recognized by the OS that is to be backed up. The second memory area is recognized means that the VHD file 115 serving as the second memory area is in a mounted state. For example, the suspending unit 402 sets a breakpoint before a point at which the VHD file 115 is mounted, and suspends the backup unit 411 before the guest machine 103 that has been executing the guest OS 111 mounts the VHD file 115.

The suspending unit 402 may be executed by the host OS serving as the particular OS or by another OS. The result of the suspension is stored to the memory area of the RAM 203, magnetic disk 205, optical disk 207, etc.

The determining unit 403 has a function such that when an OS that is to be backed up is detected, the determining unit 403 determines whether the second memory area, which is a copying destination for information concerning resources, is present, through an operation by the particular OS. The second memory area is, for example, the VHD file 115 or the configuration file storage folder 123 in the VHD file 115. The configuration file storage folder 123 is created in advance by the backup tool 121 before the guest OS 111 that is the OS that is to be backed up is shut down. A path to the configuration file storage folder 123 corresponding to the OS that is to be backed up is stored in the guest machine management table 421.

For example, the determining unit 403 determines whether the configuration file storage folder 123 is present in the VHD file 115, through an operation by the host OS 110. The determining unit 403 may be executed by the host OS serving as the particular OS or by another OS that is not the host OS or the OS that is to be backed up. The result of the determination is stored to the memory area of the RAM 203, magnetic disk 205, optical disk 207, etc.

The extracting unit 404 has a function such that when an OS that is to be backed up is detected, the extracting unit 404 extracts from the first memory area, information concerning resources used by the OS that is to be backed up among computer resources. The first memory area is the memory area that the particular OS is authorized to access and that the OS that is to be backed up is not authorized to access. When the guest OS 111 is detected as the OS that is to be backed up, for example, the extracting unit 404 extracts configuration information used by the guest OS 111, from the host OS managed area 114 serving as the first memory area, through an operation by the host OS 110.

The extracting unit 404 may be executed by the host OS serving as the particular OS or by another OS that is authorized to access the first memory area and is not the OS that is to be backed up. For example, the host OS may temporarily transfer access authority to this other OS, which may be the OS that has executed the detecting unit 401 or may be yet another OS.

When the determining unit 403 determines that a memory area as a copying destination is present, the extracting unit 404 may extract information concerning resources from the first memory area. A pointer, etc., for the extracted configuration information is stored in the memory area of the RAM 203, magnetic disk 205, optical disk 207, etc.

The encrypting unit 405 has a function of using a secret-key based on identification information of a virtual machine corresponding to an OS that is to be backed up to encrypt information related to resources and extracted by the extracting unit 404. For example, the encrypting unit 405 encrypts the configuration information using the secret-key that is generated by a method using the identification information of the virtual machine as an initialization vector. As an encrypting method, for example, a block cipher method may be adopted according to which the configuration information is divided into information blocks each having a fixed length so that encryption is performed in blocks. Specific encryption algorithms include the triple data encryption standard (triple DES) and the rivest cipher 5 (RC 5). The encrypted configuration information is stored in the memory area of the RAM 203, magnetic disk 205, optical disk 207, etc.

The generating unit 406 has a function of generating a hash value for information concerning resources extracted by the extracting unit 404, using a given hash function. The given hash function is, for example, the message digest algorithm 5 (MD 5), the security hash algorithm-1 (SHA-1), etc. For example, the generating unit 406 generates a hash value for the configuration information, according to the MD 5. The generated hash value is stored in the memory area of the RAM 203, magnetic disk 205, optical disk 207, etc.

The copying unit 407 has a function of copying information concerning resources from the first memory area to the second memory area to which the particular OS and an OS that is to be backed up are authorized to access. For example, the copying unit 407 copies the configuration information from the first memory area to the second memory area. The copying unit 407 may copy the information concerning resources from the first memory area to the second memory area before the second memory area is recognized by the OS that is to be backed up. For example, the copying unit 407 copies the configuration information from the first memory area to the second memory area while the second memory area is not yet mounted.

The copying unit 407 may be executed by the host OS serving as the particular OS or by another OS that is authorized to access the first memory area and is not the OS that is to be backed up. For example, the host OS may temporarily transfer access authority to this other OS.

The copying unit 407 may copy the information concerning resources encrypted by the encrypting unit 405. The copying unit 407 may copy the information concerning resources and a hash value generated by the generating unit 406.

After detection of the OS that is to be backed up and extraction of the configuration information, the copying unit 407 may periodically attempt to copy the configuration information to the second memory area while the second memory area is not yet mounted. For example, at a point in time right after detection of the OS that is to be backed up, if the second memory area is mounted by the OS that is to be backed up, any copying attempt by the copying unit 407 ends in failure unless the second memory area is set as a shared area for the copying unit 407. However, in periodically attempting copy the configuration information, the copying unit 407 may attempt the copying when the OS that is to be backed up temporarily unmounts the second memory area consequent to a restarting of the guest machine by the backup tool 121. In this case, the copying unit 407 succeeds in copying the configuration information.

If it is determined that a memory area serving as a copying destination is present, the copying unit 407 may copy the information concerning resources, from the first memory area to the memory area serving as the copying destination while the second memory area has not yet been recognized by the OS that is to be backed up. For example, if the configuration file storage folder 123 is present, the copying unit 407 may copy the information concerning resources to the configuration file storage folder 123.

The restarting unit 408 has a function of restarting a process of backing up an OS that is to be backed up and that has been suspended by the suspending unit 402, after information concerning resources is copied. For example, the restarting unit 408 cancels the suspension of the guest machine 103 suspended at a breakpoint and causes the backup unit 411 to restart the backup operation. The restarting unit 408 may be executed by the host OS serving as the particular OS or by another OS.

The backup unit 411 has a function of backing up information concerning resources after copying of the information concerning resources to the second memory area. For example, the backup unit 411 writes the configuration file 112 to the backup image file 305 in the disk 304. The backup unit 411 may write to the backup image file 305, an OS that is to be backed up. For example, if the OS that is to be backed up is already written in the backup image file 305, the backup unit 411 does not back up the OS that is to be backed up and backs up only the configuration file 112. In this case, the guest machine 103 may be restarted by the guest OS 111, which is the OS that is to be backed up.

The backup unit 411 may cause software recorded on the recording medium 122 detected by the detecting unit 401 to back up the OS that is to be backed up and the information concerning resources. For example, the backup unit 411 causes the backup tool 121 recorded on the recording medium 122 to write the guest OS 111 and the configuration file 112 to the backup image file 305 in the disk 304.

The decoding unit 412 has a function of decoding encrypted information concerning resources, using a secret-key identical to a secret-key used by the host OS 110. To use the secret-key that is identical to the secret-key used by the host OS 110, for example, the decoding unit 412 preliminarily determines, as an encryption algorithm to adopt, an encryption algorithm that is identical to an algorithm adopted by the host OS 110 and uses identification information of the guest machine 103 as an initialization vector. For example, the decoding unit 412 decodes the configuration information encrypted using the secrete-key. The decoded configuration information is stored to the memory area of the RAM 203, magnetic disk 205, optical disk 207, etc.

The generating unit 413 has a function of generating a hash value for information concerning resources at a copying destination using a hash function identical to a given hash function. For example, the generating unit 413 generates a hash value for the configuration file 112 copied to the configuration file storage folder 123. The generated hash value is stored in the memory area of the RAM 203, magnetic disk 205, optical disk 207, etc.

The determining unit 414 has a function of determining the authenticity of information concerning resources in a copying destination using a hash value generated by the generating unit 413 and a hash value for the copying destination. For example, when the generated hash value matches the hash value for the copying destination, the determining unit 414 determines that the information concerning resources at the copying destination has not been tampered with and is therefore authentic. The result of the determination is stored to the memory area of the RAM 203, magnetic disk 205, optical disk 207, etc.

The writing unit 415 writes an OS that is to be backed up and information concerning resources to the backup image file 305. For example, the writing unit 415 writes the guest OS 111 and the configuration information to the backup image file 305. If it is determined that information concerning resources at a copying destination has not been tampered with and is therefore authentic, the writing unit 415 may write the information concerning resources to the backup image file 305.

FIG. 5 is an explanatory diagram of an example of the contents of the backup image file. The configuration file 112 is present on the host machine 102, for example, as a file “xxx.xml”. The agent 113 copies ““xxx.xml” to the configuration file storage folder 123. The backup tool 121 writes to the backup image file 305, the configuration file 112 at the copying destination and a disk image of the guest machine 103. The disk image of the guest machine 103 is an image file created by copying the entire backed up guest machine 103 into a data file.

The configuration file 112 includes information concerning a basic input/output system (BIOS), a virtual network interface card (NIC) media access control (MAC) address, CPUs, memory, and hardware. The BIOS information includes, for example, time information and the time consumed for starting the BIOS. The virtual NICMAC address is a MAC address set for a virtual NIC assigned to a virtual machine. The information concerning CPUs includes, for example, the number of CPUs used by a virtual machine. The information concerning memory includes, for example, a memory volume assigned to a virtual machine. The information concerning hardware includes, for example, I/O settings and display settings.

FIG. 6 is an explanatory diagram of an example of the contents of the guest machine management table. The guest machine management table 421 stores therein supervising information of each guest machine. The guest machine management table 421 of FIG. 6 has a record 421-1. The guest machine management table 421 has six fields, including a virtual machine ID field, process ID field, a debugger attach flag field, a VHD file path field, a configuration file path field, and a configuration file storage folder path field. In the virtual machine ID field, an ID for uniquely identifying a virtual machine on the host machine is stored. In the process ID field, a process ID for a virtual machine on the host machine is stored. A virtual machine is treated as one process on the host machine.

In the debugger attach flag field, a flag that indicates whether a debugger process is attached to a virtual machine. If the debugger process is attached to the virtual machine, “0b1” is stored in the debugger attach flag field. If the debugger process is not attached to the virtual machine, “0b0” is stored in the debugger attach flag field. “0b” is a prefix indicating a binary figure.

In the VHD file path field, a physical path to the VHD file 115 on the host OS is stored. In the configuration file path field, a physical path to the configuration file 112 on the host OS is stored. In the configuration file storage folder path field, a path to a folder for storing the configuration file 112 therein in a virtual hard disk that mounts the VHD file 115 is stored.

For example, the record 421-1 indicates that a virtual machine with a virtual machine ID “103” and a process ID “0xAAAAAAAA” is not connected to the debugger process. The record 421-1 also indicates that for the virtual machine with the virtual machine ID “103”, the VHD file 115 is present at “D:¥VM¥aa.vhd” on the host machine and the configuration file 112 is at “D:¥VM¥aa.xml”. When a drive letter that is given when the host machine mounts the VHD file 115 is assumed to be “C”, the record 421-1 indicates that a path to the configuration file storage folder 123 is represented as “C:¥DcW”.

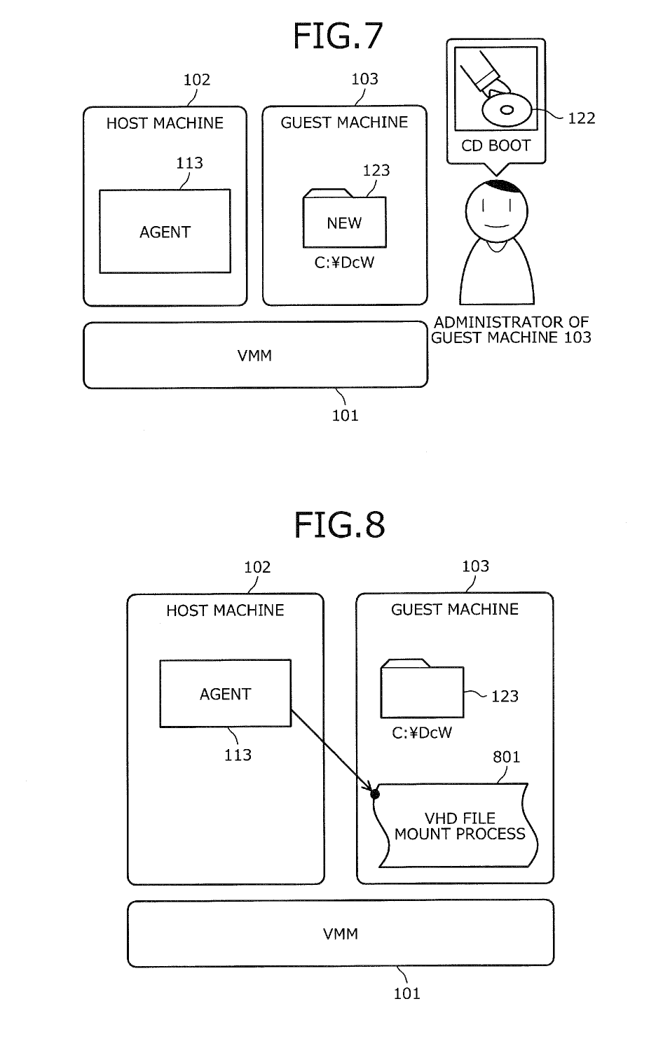

The agent 113 executes the backup process, referring to the guest machine management table 421 of FIG. 6. An example of an operation during the backup process will be described with reference to FIGS. 7 to 9.

FIG. 7 is an explanatory diagram (1) of an example of operation during the backup process. At the start of operation of the information processing apparatus 100, the administrator, etc. of the host machine 102 installs the agent 113 in the host machine 102. For example, in an operational environment where the host machine 102 is treated as a virtual machine to be operated by the information processing apparatus 100, the host machine 102 detects the recording medium 122 and executes a program recorded on the recording medium 122. Subsequently, when the administrator, etc. of the host machine 102 selects installation of the agent 113 from a menu of the backup tool 121 displayed by the recorded program, the host machine 102 installs the agent 113.

The installed agent 113 generates a secret-key based on a virtual machine ID for a guest machine supervised by the host machine 102. The installed agent 113 then monitors the states of the guest machines 103 and 104 and regularly checks whether the recording medium 122 has been installed in the guest machines. An operation to follow detection of installation of the recording medium by the agent 113 will be described later with reference to FIG. 8.

The recording medium 122 is installed in the guest machine 103 by the administrator, etc., of the guest machine 103, and the guest machine 103 starts the backup tool 121. The backup tool 121 creates the configuration file storage folder 123 on a particular path. After creating the configuration file storage folder 123, the backup tool 121 shuts down the guest machine 103 to suspend execution of the guest OS 111 and then restarts the guest machine 103 through a booting process by the recording medium 122.

FIG. 8 is an explanatory diagram (2) of an example of operation during the backup process. FIG. 8 depicts a situation where the information processing apparatus 100 has detected the recording medium 122 in a readable state. Following the detection of the recording medium 122, a breakpoint is set before a point of a VHD file mount process in program code 801 for the guest machine 103. The program code 801 is a program for an OS recorded on the recording medium 122. For example, a debugger process started by the agent 113 sets the breakpoint, which is a software breakpoint or hardware breakpoint.

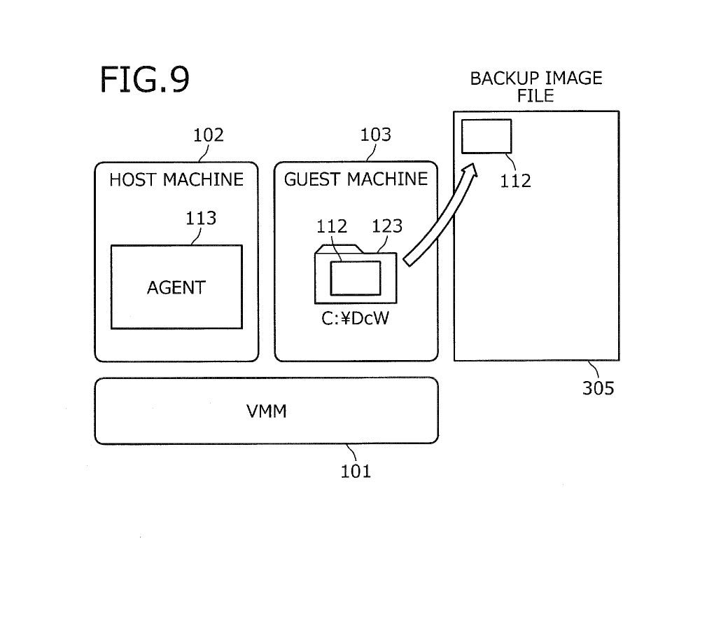

As a result, the agent 113 suspends the operation of the guest machine 103 through the breakpoint set before a point at which the restarted guest machine 103 attempts to mount the VHD file 115 in which the guest OS 111 is stored. The agent 113, therefore, can copy the configuration file 112 to the VHD file 115 while the VHD file has not yet been mounted by the guest machine. An operation to follow the suspension of the guest machine 103 through the breakpoint will be described later with reference to FIG. 9.

FIG. 9 is an explanatory diagram (3) of an example of operation during the backup process. FIG. 9 depicts the information processing apparatus 100 in which the operation of the guest machine 103 is suspended through the breakpoint. The agent 113 mounts the VHD file 115, which the guest machine 103 intends to mount, and determines whether the configuration file storage folder 123 is present on a particular path.

If the configuration file storage folder 123 is present on the particular path, to indicate that the backup tool 121 has been executing the backup process before the guest machine is shut down, the agent 113 copies the configuration file 112 to the configuration file storage folder 123. If the configuration file storage folder 123 is not present on the particular path, to indicate execution of an ordinary guest machine shut down process, the agent 113 does nothing. If the configuration file storage folder 123 is present on the path and the configuration file 112 has already been copied, the agent 113 determines that a restore process is in progress.

When the configuration file 112 is copied to the configuration file storage folder 123, the agent 113 may encrypt the configuration file 112 using a secret-key generated based on a virtual machine ID and copy the encrypted configuration file 112 to the configuration file storage folder 123. The agent 113 may generate a hash value for the configuration file 112 and copy the configuration file 112 and the generated hash value to the configuration file storage folder 123. The agent 113 may generate a hash value for the already encrypted configuration file 112 or encrypt a hash value for the configuration file 112.

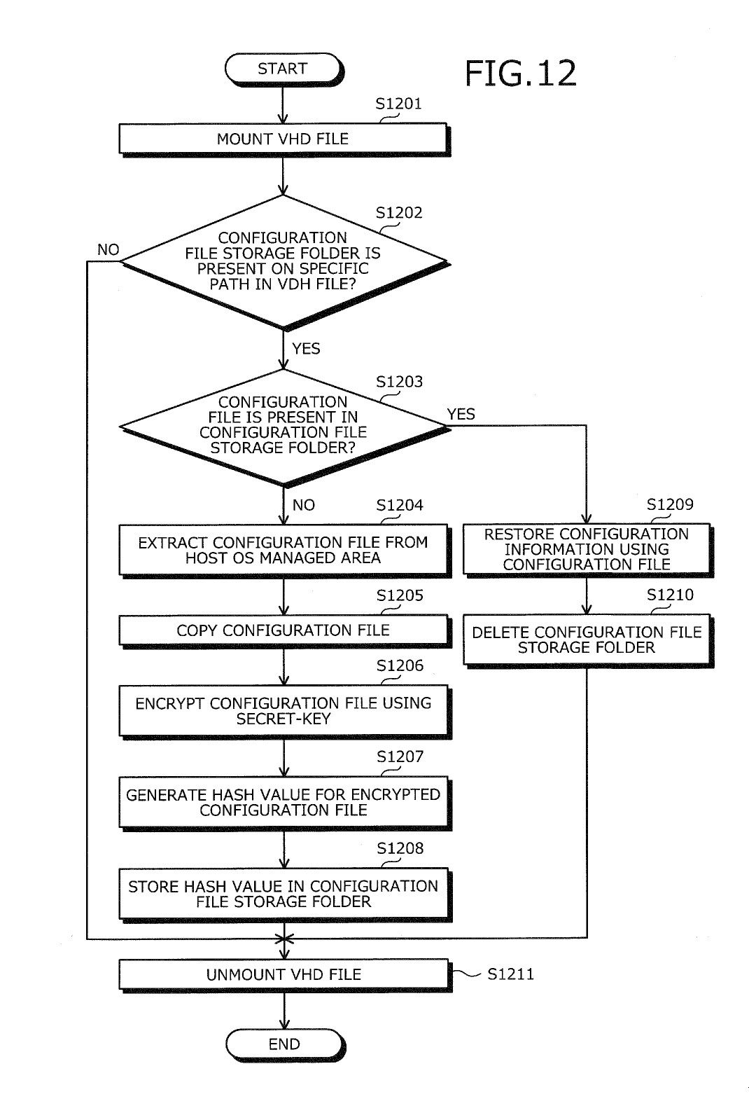

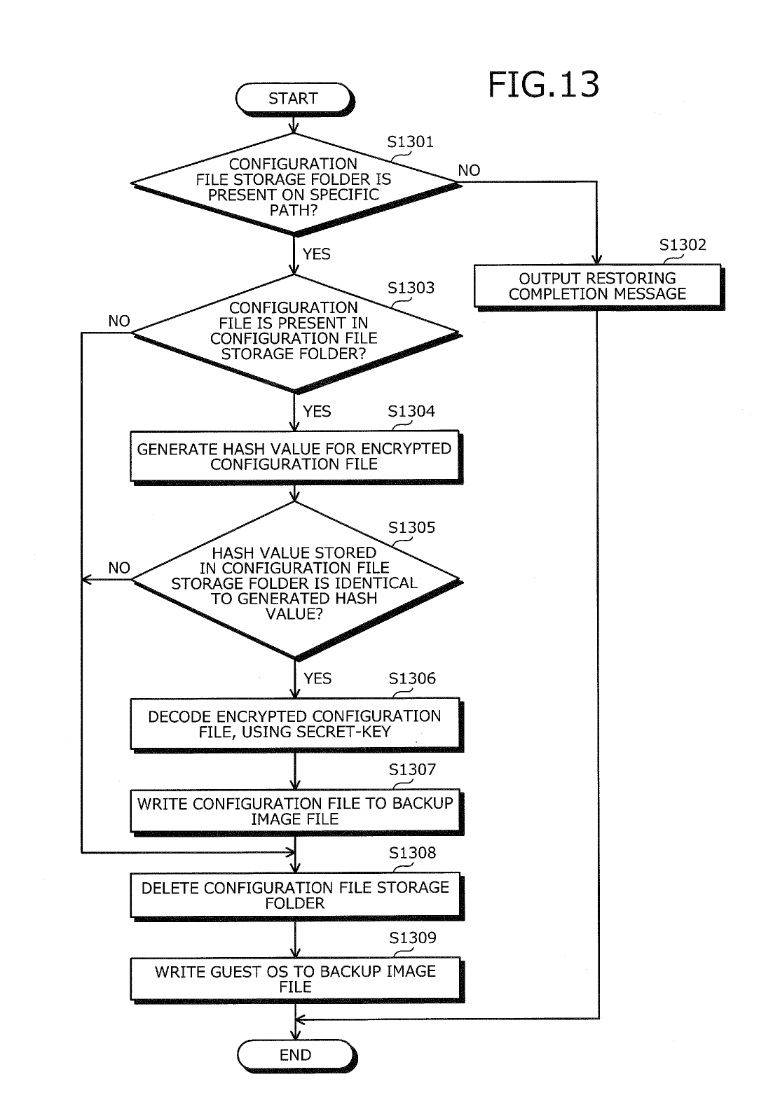

The agent 113 and the backup tool 121 decide in advance which of the above four processes each is to execute. Flowcharts of FIGS. 12 and 13 to be described later indicate process flows in an assumed case where the agent 113 adopts the process of generating a hash value for the encrypted configuration file 112.

After copying to the configuration file storage folder 123, the agent 113 cancels the suspension of operation of the guest machine 103. The guest machine 103 that has been released from the suspended state and booted by the recording medium 122 restarts the backup tool 121. The backup tool 121 then mounts the VHD file 115 in which the guest OS 111 is stored. If it is decided that any one among the configuration file 112 and the hash value copied to the configuration file storage folder 123 is to be encrypted, the backup tool 121 generates a secret-key based on the virtual machine ID for the guest machine 103.

After the VHD file is mounted, the backup tool 121 writes the configuration file 112 at the copying destination to the backup image file 305, and deletes the configuration file storage folder 123. Deletion of the configuration file storage folder 123 prevents a case where when the guest machine 103 executes a normal restart process, the agent 113 misinterprets the restart process as the backup process. The backup tool 121 finally writes a disk image of the guest machine 103 to the backup image file 305.

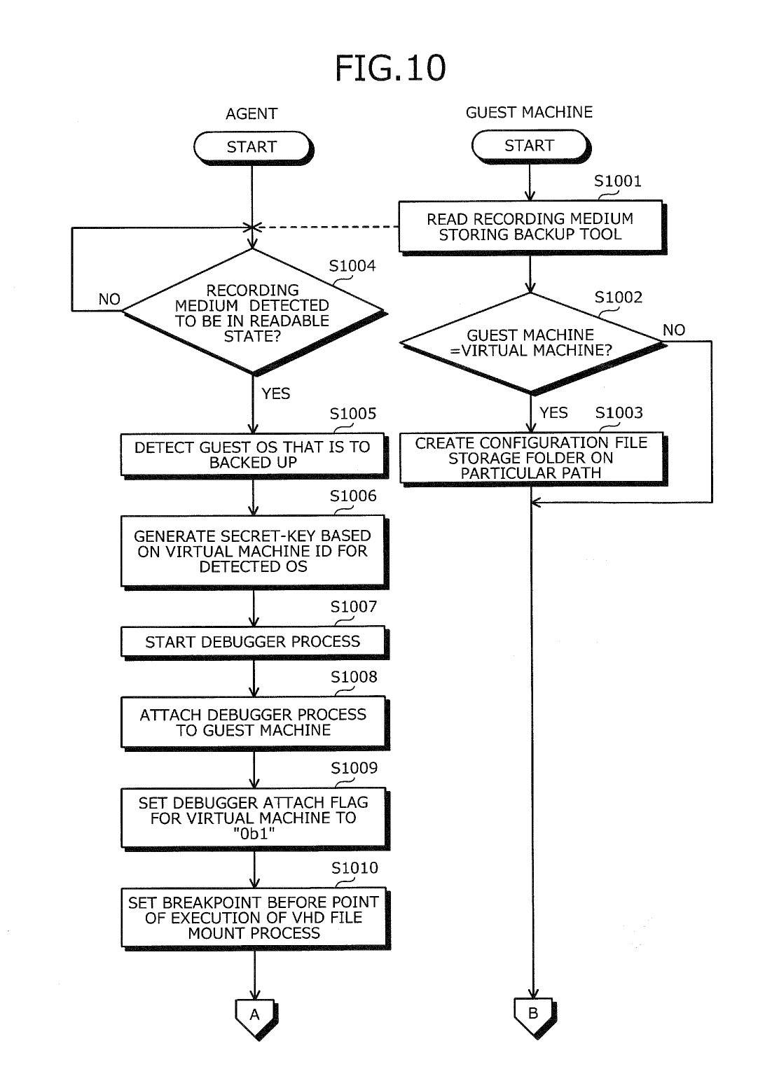

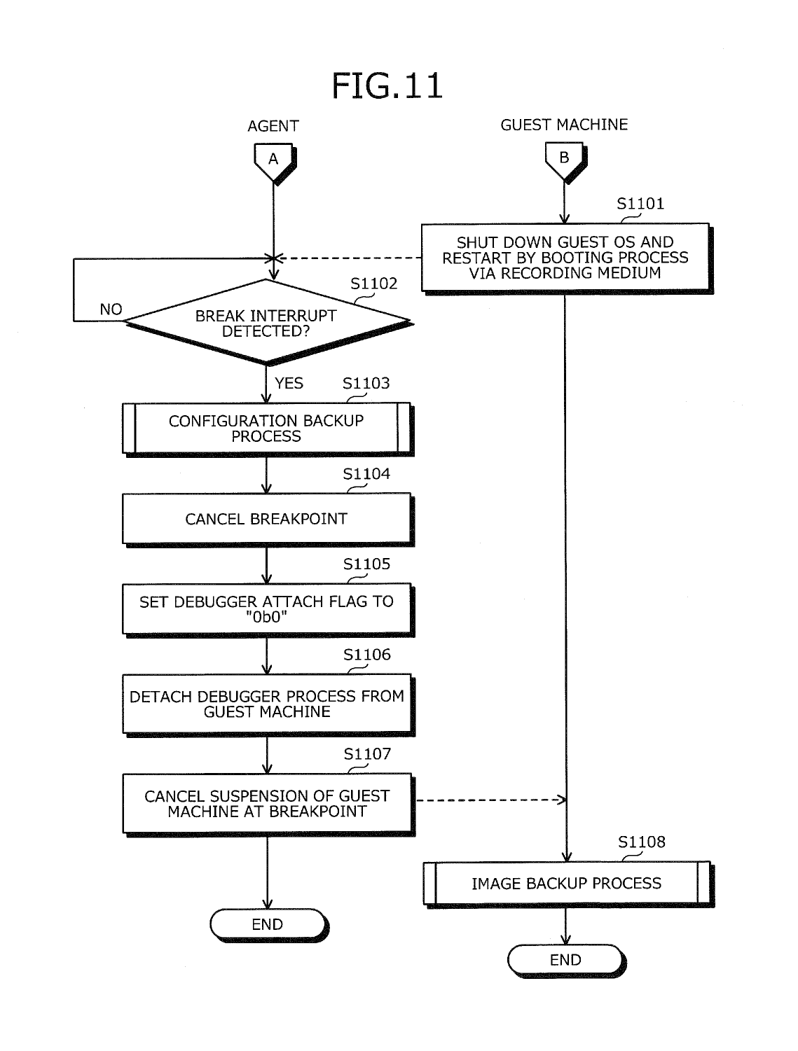

Flowcharts of the operations described in FIGS. 7 to 9 are depicted in FIGS. 10 to 13. FIGS. 10 and 11 depict a backup process performed by the information processing apparatus 100 as a whole. FIG. 12 depicts a configuration file backup process performed by the agent 113. FIG. 13 depicts an image backup process performed by the backup tool 121. FIGS. 10 to 13 indicate process flows in an assumed case where the recording medium 122 storing the backup tool 121 therein is installed in the information processing apparatus 100.

FIG. 10 is a flowchart (1) of an example of the backup process. The guest machine 103 reads the recording medium 122 storing the backup tool 121 therein (step S1001). Then, the backup tool 121 of the recording medium 122 determines whether the guest machine 103 is a virtual machine (step S1002). As one method of determining whether a machine to be backed up is a virtual machine, for example, the backup tool 121 determines whether the guest machine 103 is a virtual machine by referring to setting information, registry information, etc. of the guest OS 111.

If the guest machine 103 is a virtual machine (step S1002: YES), the guest machine 103 creates the configuration file storage folder 123 on a particular path (step S1003). After creating the configuration file storage folder 123 on the particular path or if the guest machine 103 is not a virtual machine (step S1002: NO), the guest machine 103 proceeds to the operation at step S1101 depicted in FIG. 11.

The agent 113 determines whether the recording medium 122 has been detected to be in a readable state (step S1004). If the recording medium 122 is not in a readable state (step S1004: NO), the agent 113 executes the operation at step S1004 again after a given time has passed. If the recording medium 122 in a readable state (step S1004: YES), the agent 113 detects the guest OS 111 that is to be an OS that is to be backed up (step S1005). The agent 113 then generates a secret-key based on the virtual machine ID for the detected OS that is to be backed up (step S1006).

After generating the secret-key, the agent 113 starts a debugger process (step S1007) and attaches the debugger process to the guest machine 103 (step S1008). Because a debugger process is generated for each guest machine, the agent 113 can deal with back up processes executed simultaneously at multiple guest machines. After attaching the debugger process to the guest machine 103, the agent 113 sets a debugger attach flag for the guest machine 103 to which the debugger process is attached, to “0b1” (step S1009), and sets a breakpoint before a point of execution of the VHD file mount process (step S1010). After setting the breakpoint, the agent 113 proceeds to the operation at step S1102 of FIG. 11.

FIG. 11 is a flowchart (2) of an example of the backup process. The guest machine 103 shuts down the guest OS through the backup tool 121 of the recording medium 122, and restarts the guest OS by a booting process by the recording medium 122 (step S1101). If a breakpoint is set before a point at which the guest machine 103 mounts the VHD file 115, the guest machine 103 suspends operation.

The agent 113 determines whether a break interrupt has been detected (step S1102). If no break interrupt has been detected (step S1102: NO), the agent 113 executes the operation at step S1102 again after a given time has passed. If a break interrupt has been detected (step S1102: YES), the agent 113 executes the configuration backup process (step S1103). The details of the configuration backup process will be described later with reference to FIG. 12. The agent 113 then cancels the breakpoint (step S1104) and sets the debugger attach flag to “0b0” (step S1105). After setting the debugger attach flag, the agent 113 detaches the debugger process from the guest machine 103 (step S1106), cancels the suspension of the guest machine at the breakpoint (step S1107), and ends the backup process.

The guest machine 103 having been released from the suspended state by the operation at step S1107, executes the image backup process (step S1108), and ends the backup process. The details of the image backup process will be described later with reference to FIG. 13.

FIG. 12 is a flowchart of an example of the configuration file backup process by the agent. The agent 113 mounts the VHD file 115 (step S1201), and determines whether the configuration file storage folder 123 is present on a particular path in the VHD file 115 (step S1202). If the configuration file storage folder 123 is present (step S1202: YES), the agent 113 determines whether the configuration file 112 is present in the configuration file storage folder 123 (step S1203). If the configuration file 112 is not present (step S1203: NO), the agent 113 extracts the configuration file 112 from the host OS managed area 114 (step S1204).

After extracting the configuration file 112, the agent 113 copies the configuration file 112 to the configuration file storage folder 123 (step S1205). The agent 113 then encrypts the configuration file 112 using a secret-key (step S1206), generates a hash value for the encrypted configuration file 112 (step S1207), and stores the hash value in the configuration file storage folder 123 (step S1208).

If the configuration file 112 is present (step S1203: YES), the agent 113 restores configuration information using the configuration file 112 (step S1209), and deletes the configuration file storage folder 123 (step S1210). Following step S1208 or S1210 or if the configuration file storage folder 123 is not present (step S1202: NO), the agent 113 unmounts the VHD file 115 (step S1211) and ends the configuration file backup process.

FIG. 13 is a flowchart of an example of the image backup process by the backup tool. The backup tool 121 determines whether the configuration file storage folder 123 is present on a particular path (step S1301). If the configuration file storage folder 123 is not present (step S1301: NO), the backup tool 121 outputs a restoring completion message (step S1302), and ends the image backup process. The message may be output to a console of the backup tool 121 or stored in the form of a text file to the memory area of the information processing apparatus 100.

If the configuration file storage folder 123 is present (step S1301: YES), the backup tool 121 determines whether the configuration file 112 is present in the configuration file storage folder 123 (step S1303). If the configuration file 112 is present (step S1303: YES), the backup tool 121 generates a hash value for the encrypted configuration file 112 (step S1304).

The backup tool 121 then determines whether a hash value stored in the configuration file storage folder 123 is identical to the generated hash value (step S1305). If the hash values are identical (step S1305: YES), the backup tool 121 decodes the encrypted configuration file 112, using the secret-key (step S1306), and writes the configuration file 112 to the backup image file 305 (step S1307).

After writing the configuration file 112, if the configuration file 112 is not present (step S1303: NO) or the hash values are not identical (step S1305: NO), the backup tool 121 deletes the configuration file storage folder 123 (step S1308). After deleting the configuration file storage folder 123, the backup tool 121 writes the guest OS to the backup image file 305 (step S1309). After writing the guest OS, the backup tool 121 ends the image backup process.

As described above, according to the backup method and a backup program, before the memory area of a virtual machine is mounted, virtual machine configuration information in the first memory area that is the host OS managed area is copied in advance to the second memory area that a guest machine is authorized to access.

Thus, according to the backup method, the configuration information can be backed up efficiently at the virtual machine without giving the authority of the host OS to the virtual machine. If the authority of the host OS is given to the virtual machine, the virtual machine is allowed to operate another virtual machine, which creates a risk of erroneous operation of the different virtual machine. If the administrator of the virtual machine is provided with a password that gives the administrator access authority, a new password must be set after the end of copying, which results in an extra process. In a conventional case where the host authority is not given to the administrator of the virtual machine, the administrator of the virtual machine is required to manually input configuration information transmitted from the administrator of the host machine, etc. As a result, configuration information input takes a long time or data restoration may be incomplete in some cases.

According to the backup method, when a memory area serving as a copy destination for configuration information is present in the second memory area, the configuration information may be extracted from the first memory area. As a result, through the backup method, it is determined that the backup process by the backup tool has been started. Based on the determination, OSs that are to be backed up can be narrowed down.

According to the backup method, before the second memory area is recognized by an OS that is to be backed up or the OS of the recording medium, the backup process may be suspended and information concerning resources may be copied. Hence, according to the backup method, because the backup process is suspended before the OS that is to be backed up is recognized, copying the configuration information before the backup process is ensured.

According to the backup method, when the recording medium in a computer-readable state is detected, an OS that is to be run may be detected as an OS that is to be backed up. In this manner, according to the backup method, a possibility of backup by the recording medium is detected. Based on this detection result, OSs that are to be backed up can be narrowed down.

According to the backup method, configuration information may be encrypted using a secret-key based on a virtual machine. The configuration information includes, for example, a virtual NICMAC address. If the virtual MAC address is acquired by a third party, the third party may make unauthorized access by posing as an authorized user using the acquired virtual MAC address. The backup method prevents such activity by encrypting the configuration information.

According to the backup method, a hash value for configuration information may be generated so that the authenticity of the configuration information is determined based on the hash value. The configuration information includes, for example, information of a memory volume assigned to a virtual machine, and a third party may falsify the configuration information to reduce the assigned memory volume. According to the backup method, the hash value is generated so that the configuration information that has not been tampered with at all is backed up.

According to the backup method, a virtual machine including the configuration file can be backed up through an operation substantially the same as a conventional operation for backing up a physical environment. As a result, the backup method offers an effect such that the administrator of a virtual machine who is less versed with virtual machines does not have to learn complicated operations for backing up the virtual machine including the configuration file.

According to the backup method, when a physical server that executes the host OS is damaged, the administrator can restore the system that includes configuration information more quickly and accurately than by performing restoration by manual input of the configuration information.

The backup method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to one aspect of the embodiment, information concerning resources can be backed up efficiently.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A backup method comprising:
detecting a first OS that is to be backed up, among a plurality of OSs running on a computer and exclusive of a second OS;
extracting information concerning resources used by the first OS among resources of the computer, the information being extracted upon detecting the first OS and from a first memory area that the second OS is authorized to access and that the first OS is not authorized to access;
copying the information from the first memory area to a second memory area that the second OS and the first OS are authorized to access; and
backing up the information of resources after copying the information to the second memory area, wherein the backup method is executed by the computer.

2. The backup method according to claim 1, further comprising
executing via the second OS, a process of determining whether the second memory area serving as a copying destination for the information is present, wherein
the extracting includes extracting the information from the first memory area, upon determining that the second memory area is present.

3. The backup method according to claim 1, further comprising:
suspending before the first OS recognizes the second memory area, a process of backing up the first OS; and
resuming the process of backing up the first OS after copying the information.

4. The backup method according to claim 1, further comprising
executing a process of detecting a recording medium in a computer-readable state, wherein
the detecting of the first OS includes detecting as the first OS, an OS that is to be run among the OSs, upon detecting the recording medium, and
the backing up of the information after copying the information includes backing up the information via software recorded on the recording medium.

5. A non-transitory, computer-readable recording medium stores a backup program that causes a computer to execute a process comprising:
detecting a first OS that is to be backed up, among a plurality of OSs running on a computer and exclusive of a second OS;
extracting information concerning resources used by the first OS among resources of the computer, the information being extracted upon detecting the first OS and from a first memory area that the second OS is authorized to access and that the first OS is not authorized to access;
copying the information from the first memory area to a second memory area that the second OS and the first OS are authorized to access; and
backing up the information of resources after copying the information to the second memory area.
